(19) United States
(12) Patent Application Publication
(10) Pub. No.: US 2005/0040222 A1
(43) Pub. Date: Feb. 24, 2005

(54) System, apparatus and method for marking and tracking bulk flowable material

(76) Inventor: Martin C. Robinson, Cedar Rapids, IA (US)

Correspondence Address: Michael F. Williams;Simmons, Perrine, Albright & Ellwood, P.L.C., Suite 1200, 115 Third Street SE, Cedar Rapids, IA, 52401-1266, US

(21) Appl. No.: 10/952,359

(22) Filed: Sep. 28, 2004

Related U.S. Application Data
(63) Continuation-in-part of application No. 09/681,065, filed on Dec. 15, 2000, now Pat. No. 6,796,504.
(60) Provisional application No. 60/171,225, filed on Dec. 16, 1999.

(51) Int. Cl. G06F 17/00

(52) U.S. Cl. 235/375

(57) ABSTRACT

A method and apparatus for identifying a characteristic of a bulk flowable material. A marker system for a bulk flowable material including a marker containing information related to the bulk flowable material. The marker being coupled with one or more granules or elements of the bulk flowable material so that the marker will migrate with surrounding granules.

### CROSS REFERENCE TO RELATED APPLICATIONS AND INCORPORATION BY REFERENCE

This application is a continuation-in-part of U.S. application No. 09/681,065, filed Dec. 15, 2000, said application No. 09/681,065 in turn claims the benefit of U.S. Provisional Application No. 60/171,225, filed Dec. 16, 1999. The entire specification of U.S. Provisional Application No. 60/171,225, filed Dec. 16, 1999, including all text and drawing figures is hereby incorporated herein by this reference. Also, the entire specification of U.S. application No. 09/681,065, filed Dec. 15, 2000, including all text and drawing figures is hereby incorporated herein by this reference.

### BACKGROUND OF THE INVENTION

In the past, identification of bulk flowable materials was accomplished by visual identification. Subtle distinctions, involving traits not readily visible to the human senses, were generally not drawn. Today, however, handlers of bulk flowable materials are increasingly being called upon to make fine distinctions related to the materials they are handling. Consequently, there exists a need to provide ready identification of a material's specific trait or traits to those responsible for storing, transporting, processing or otherwise handling the material.

The treatment traditionally given agricultural crops provides one example of the types of practices applicable to bulk flowable materials in general. Previously, intermingling of different varieties of a crop, such as a crop of corn for example, was commonplace in elevators and storage facilities. For example, many different varieties of corn would be accumulated, stored and transported together as one commodity. Each variety was treated as being equivalent to each of the other varieties. There was no need to segregate the varieties to maintain a purity standard or for some other purpose.

Recently, however, the differences between the varieties of a single crop type, for example corn or soybeans, have become significant. In addition, the number of different varieties continue to increase. As a result, a need to identify and segregate the varieties from each other has arisen.

For example, the creation and expanding use of genetically modified organisms (GMOs) have created many significant identification, tracking and segregation issues. Consumer opposition to the inclusion of such crops into the food and processing stream is evident in many countries. For example, Roundup Ready corn varieties, which are widely grown in the United States, have been prohibited from import into the European Community.

Further, economic factors also contribute to the need to identify, track and segregate. Due to the consumer opposition to GMOs, premium prices may be paid for crops that can be demonstrated to be non-GMO crops. In addition, some of the developed varieties have differences significant enough to command a premium price. For example, a high oil corn has been developed that has a higher oil content than “commodity” corn. The higher oil content makes high oil corn a superior product for some applications, such as feed or processing. As a result, a higher price can be obtained for this product.

Crops with genetic modifications or specific traits are often visually indistinguishable from one another. They are also indistinguishable from crops that do not contain the various modifications or traits. Analysis of varying complexity can be performed, using chemical solvents or infrared spectrum photometry for example, to identify a given sample. These tests are performed at a point of transfer, such as at the time of sale, to identify the material being sold.

The testing procedure, however, is time consuming and it disrupts the flow of the material through the processing points. Further, even if a sub-sample has been tested and identified, portions of the remaining lot of the material may have a trait different from that of the sub-sample tested. In addition, current testing practice involves delaying a shipment or truckload of the crop until the testing is complete.

In order to avoid the testing procedure, several handlers use a verification procedure. After testing, the crop is transferred to a holding bin designated for crops of that particular trait or class of traits. Current verification practice entails the signing of a statement by the crop provider or producer that verifies the genetic origin of the crop. The usefulness and accuracy of this system depends in large measure on the truthfulness and accuracy of the verifier. Further, if at any subsequent point, the crop is intermingled with other varieties, the value of the identification will be lost and, if further testing is not performed, uncertainty will be present at each subsequent stage of handling.

Consequently, there exists a need for improved systems, methods and apparatuses for identifying various properties of bulk flowable materials, and in addition, for readily and sufficiently identifying such material at subsequent stages of handling or processing.

### SUMMARY OF THE INVENTION

It is an object of the present invention to provide an apparatus and method for identifying a property of a bulk flowable material.

It is a feature of the present invention to utilize a marker to identify a characteristic of a bulk flowable material.

It is an advantage of the present invention to enable a particular bulk flowable material to be identified from a plurality of similar but different bulk materials at one or more stages of its handling.

It is another object of the present invention to provide a marker dispenser apparatus capable of dispensing a marker into or onto a bulk flowable material.

It is another feature to utilize a marker dispenser that is located proximate a moving flow of bulk flowable material.

It is another advantage of the present invention to provide ready and automatic marking of a bulk flowable material at one or more stages of handling.

It is yet another object of the present invention to provide a marker media for marking a bulk flowable material.

It is yet another feature to utilize a spool of marker media containing a length of bar code-style indicia that can be clipped off at any point for dispensing a bulk flowable material.

It is yet another advantage of the present invention to provide an inexpensive, accurate and reliable manner of providing a marker for a bulk flowable material.

The present invention is a system for marking a bulk flowable material, for example a harvested crop, for later identification. Further, the method and components of the invention permit it to be implemented in a cost effective and, if desired, an at least partially automated manner. The system is useful, for example, for identifying a property of the bulk material that is not otherwise readily apparent.

The invention can also be used to mark a bulk flowable material that may later be located proximate other collected bulk flowable materials. For instance, the system can be used to identify a crop, such as a genetically modified organism or a specific variety, held in a container with crops that are not genetically modified organisms or that are of a different variety. The marked crop can be distinguished from the other crops and the information can be used to separate the marked crop from the other held crops if desired. Further, the identifying information travels with the material it is marking and is available to handlers of the material at later processing, trading or handling stages.

Accordingly, the present invention provides a system for identifying a property of a bulk flowable material.

### BRIEF DESCRIPTION OF THE DRAWINGS

The invention may be more fully understood by reading the following description of the embodiments of the invention, in conjunction with the appended drawings, wherein:

FIG. 1 depicts an embodiment of the marker dispensing system of the present invention.

FIG. 1A depicts probe system including a marker reader unit.

FIG. 2 depicts an embodiment of the marker dispensing system of the present invention that includes sensor and reading components.

FIG. 3 is a graphical depiction of a harvesting-stage embodiment of the marker dispensing system of the present invention.

FIG. 4 is a graphical depiction of a storage-stage embodiment of the marker dispensing system of the present invention.

FIG. 5 is a flowchart depiction of an embodiment of a procedure that can be used to implement the present invention.

FIG. 6 is a graphical depiction of a preprinted identification marker that can be used in an embodiment of the present invention.

FIG. 7 is a side view graphical depiction of a marker dispenser that can be used in an embodiment of the present invention.

FIG. 8 is a graphical depiction of a frontal view of the marker dispenser of FIG. 7.

FIG. 9 is a graphical depiction of an interior view of the marker dispenser of FIG. 7 including one embodiment of a cutting mechanism.

FIG. 10 is a graphical depiction of a marker dispenser including a marker supply indicator.

FIG. 11 is a graphical depiction of a reading component of the present invention.

FIG. 12 is a graphical depiction of a reading operation involving the reading component of FIG. 11.

FIG. 13 depicts the coupling of a marker with one or more elements or granules of a bulk flowable material.

FIG. 14 depicts an apparatus for segregating or selecting one or more granules or elements of a bulk flowable material.

### DETAILED DESCRIPTION

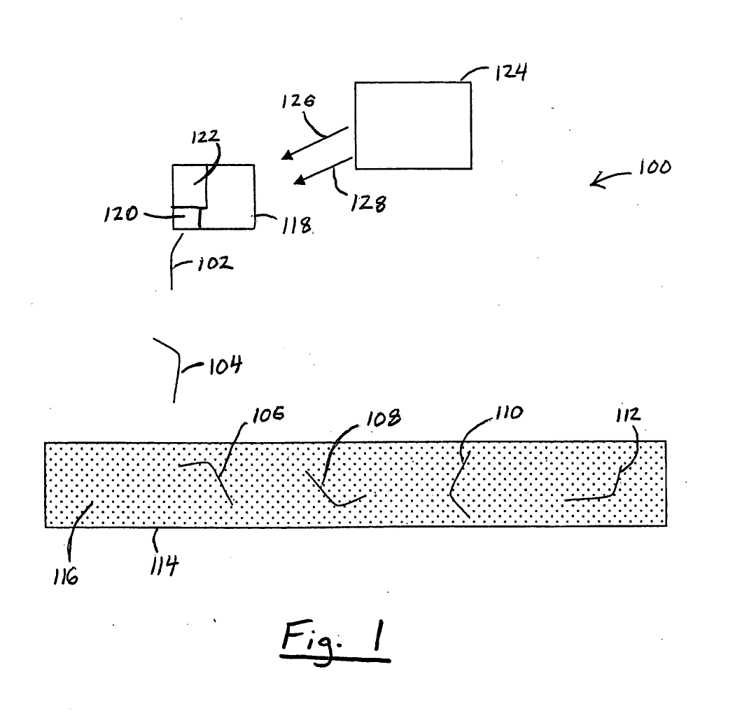

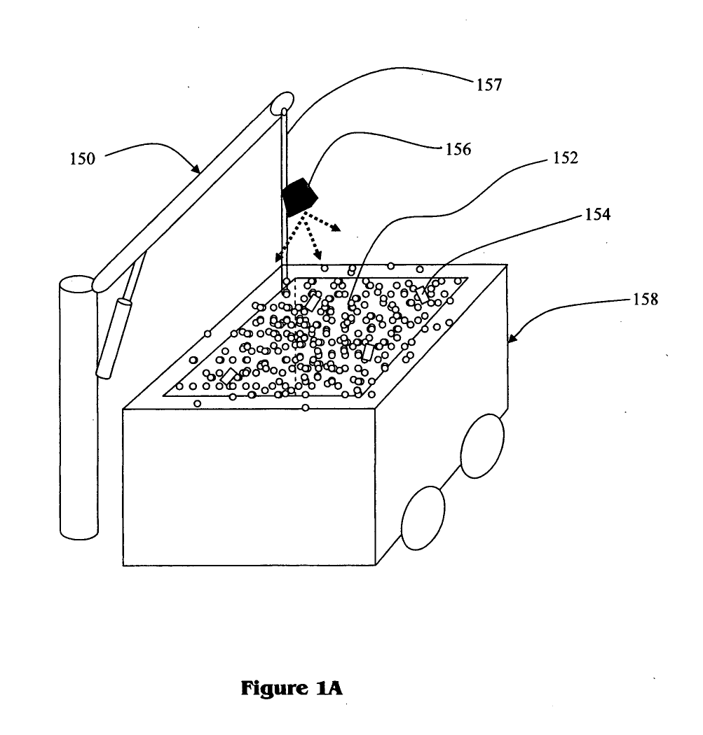

Now referring to the drawings, wherein like numerals refer to like matter throughout, there is shown in FIG. 1 an embodiment of a marker dispenser system 100 designed in accord with the teachings of the present invention. FIG. 1 depicts a plurality of identification markers 102, 104, 106, 108, 110, 112 being added to a moving stream 114 of bulk flowable material 116. The markers 102, 104, 106, 108, 110, 112 are being distributed by a dispenser unit 118. The dispenser unit 118 includes a marker media feeding component 120. In one embodiment, the dispenser unit 118 includes a marker preparation component 122 in addition to the feeding component 120. Also depicted, is a signal generation unit 124 capable of providing control signals 126, 128 to the dispenser unit 118.

As will be appreciated, the identification marker dispensing system 100 of the present invention can be beneficially used in a wide variety of applications and in conjunction with a wide variety of different bulk flowable materials 116. The present invention will be described herein primarily in connection with an agricultural application involving a material such as corn or soybeans. The invention, however, is not to be limited to agricultural applications. The teachings also apply to non-agricultural applications and to a wide variety of agricultural and non-agricultural bulk flowable materials.

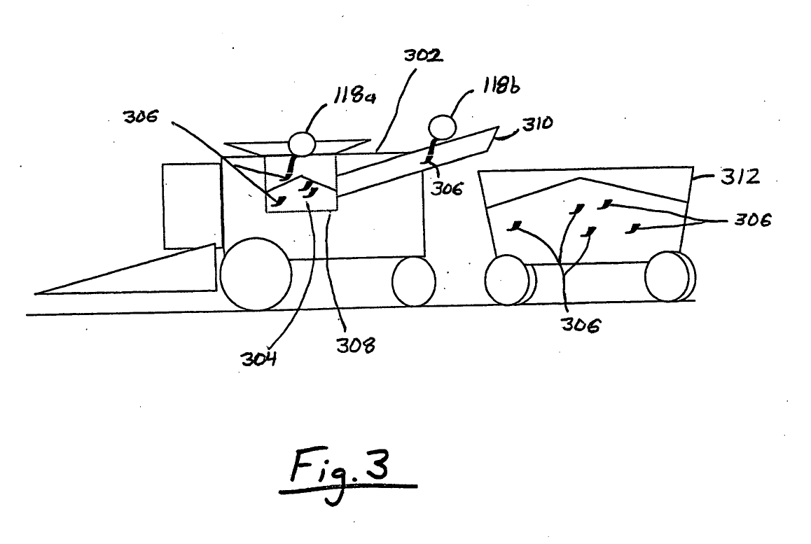

In the agricultural or horticultural context, the identification marker dispensing system 100 can be used at one or more of several different handling stages. For example, the system of FIG. 1 may be a located in a harvester apparatus, such as a combine; the identification markers being placed into the crop stream at the time of harvesting. By way of further example, the identification marker dispensing system 100 can be used during a stage of seed conditioning or processing, during application of treatments such as pesticides or fertilizers, during the transfer of the bulk flowable material to a storage or other container (see FIGS. 3 and 4), or during any of several other processing or handling stages. Another use of the system, which will be discussed in further detail below, involves marking a property of a seed at, or prior to, the time of planting the seed.

Several different types of structures or devices can be used for the identification markers 102, 104, 106, 108, 110, 112. They can be intelligent devices or unintelligent media. For example, the identification markers 102, 104, 106, 108, 110, 112 can be simple physical markers, markers containing optically-readable information, devices including a memory component, devices capable of communication via radiant energy signals or devices including one or more sensing components. In addition, some applications may employ more than one type of identification marker 102, 104, 106, 108, 110, 112 in the marker dispensing system 100. The specifics of the application at hand will influence the choice of which type of identification marker to employ.

The simple physical marker, for example, can be a marker having a specified shape, design or color. This type of marker can be made of any of a wide variety of materials. It can be made of a paper or paper-like material, cardboard, plastic, rubber, metal, fiber or other such material or materials. The marker may be designed to be durable, with the potential for reuse, or semi-durable. A semi-durable marker can have a tailored rate of degradation or can be designed to degrade when exposed to a specific substance. Consequently, semi-durable markers can provide the added advantage of easy, even automatic, removal from the bulk flowable material at the desired time or stage.

In one embodiment, information concerning a property of the bulk flowable material is communicated as a function of the color of the marker. For example, a red colored marker would indicate one trait, such as a GMO material, and a blue colored marker would indicate another trait, such as a non-GMO material. In a related embodiment, the lack of any marker in the material indicates the presence or absence of a given property. Further, several different color codes can be used for a crop handling system dealing with a large number of tracked properties or characteristics. The sizes and colors of the marker can be chosen based upon the ability to be readily identified and distinguished from the accompanying bulk flowable material being marked. The size and color characteristics can also be chosen so as to promote ready removal of the marker at a subsequent stage.

The shape-coded marker functions similarly to the color-coded marker. Markers having one shape or design are used to indicate a given property of the bulk flowable material. Other shapes or designs are used to indicate other properties. The shape and size of the identification marker can be chosen to promote marker identification, removal or both.

The markers containing optically-readable indicia may be human-readable, machine-readable or both. The human-readable marker includes alpha-numeric characters or graphical designs. This type of marker can also be machine readable. For example, it can be scanned or imaged by an optical reader device having optical character reading (OCR) or other such capabilities.

A machine-readable marker can have optical indicia that is readable only by an optical reader device or magnetic indicia readable by a magnetic reader unit. For example, a machine-readable marker having optical indicia may contain a standard one-dimensional bar code or one of the well-known two-dimensional optical codes. There currently exist a wide variety of such codes having a range of sizes, densities, capacities and. styles.

In other embodiments, the identification marker 102, 104, 106, 108, 110, 112 is a more complex, intelligent device. In one embodiment, the identification marker is an electronic identification component capable of storing data and communicating via radiant energy. For example, the identification marker can be a radio frequency identification (RFID) tag. RFID tags are currently available in large quantities and at reasonable prices. Some types of RFID tags store information that can only be read and not changed. Other types of RFID tags are writeable and additions or changes can be readily made to the stored data. In one embodiment of the invention, the tag remains in a dormant mode until activated by a predetermined signal or condition. In addition, several types and styles of hand-held and stationary RFID tag readers are available.

In another embodiment, an intelligent marker contains a sensor component. The sensor component is designed to sense one or more properties of an accompanying bulk flowable material. The identification marker 102, 104, 106, 108, 110, 112 then stores data representing the property sensed or representing the absence of the property. The identifying information need not be pre-determined and applied to this type of identification marker. The marker identifies and records the property or properties automatically, after being introduced into the bulk flowable material.

Further, the marker can be a structure composed of a combination of two or more physical components. At least one of the components is utilized for its ability to minimize migration of the marker through the bulk flowable material. This component can be chosen to be of a material, size, shape, weight or density appropriate to limit propagation of the marker in the anticipated bulk flowabte material. The identifying information can be carried by one or more other components of the marker. Thus, the marker can be designed to limit its movement, due to wind or other influences for example, away from its accompanying bulk flowable material. As a result, the marker can even more clearly and accurately indicate the boundaries or presence of its accompanying bulk flowable material.

In yet another embodiment, an identifier is deposited or placed directly on the surfaces of a portion of the bulk flowable material. In this embodiment, information concerning a property is communicated without requiring the addition of a foreign media, such as a tag or other such marker substrate, to the bulk flowable material. Instead, the information is carried on the bulk flowable material itself.

For example, a chemical marker or a color marker, such as a powder or liquid dye, is sprayed, sifted or otherwise applied to some portion, or all, of a bulk flowable material having the trait being identified. In applications wherein it is necessary to remove the marking material at some subsequent stage of processing, when the material is to be used for food for example, a marking agent with special properties can be used. For example, a marking substance that is water soluble, biodegradable, consumable or otherwise easily removed can be used. Depending on the application, soy or vegetable-based inks or dyes can be used.

The identification markers 102, 104, 106, 108, 110, 112 can be used to communicate information relating to many different properties of the accompanying bulk flowable material. In the context of agricultural crops, the properties tracked and identified include crop variety type, classification as a GMO, crop quality traits, geographic location of the field of planting, geographic location of the field or location of harvest, crop ownership, crop producer, crop caretaker, crop handler, crop treatment or any other information useful for identification, segregation or marking purposes. The crop quality property may be a trait that has been pre-identified, for example by a supplier of the seed from which the crop was created.

Alternatively, the quality properties may be traits that are identified or analyzed during processing, harvesting or other handling concurrent with, or just prior to, the dispensing of the marker. The crop handler can be, for example, an entity that plants, grows, treats, harvests, transfers, stores, processes or otherwise handles the crop lot. The crop treatment information can track, for example, pesticide, herbicide, fertilizer or other applications. The identification marker can be designed to communicate information regarding one or more of the relevant properties as demanded by the application at hand.

The identification markers disclosed above can be used singly, or in combination, in the several applications described through this specification, as well as in the many related applications that flow naturally therefrom. For example, some embodiments dispense markers containing visually or optically readable information, and more complex electronic style markers, such as RFID markers, into the same lot of bulk flowable material. Further, the markers of the present invention can be pre-printed or ready made so that at the time of introduction they need merely be inserted into the bulk flowable material. The marker can be pre-printed with a bar code or other optical information, it can be a pre-shaped or pre-colored marker, or it can be a pre-configured intelligent marker such as an RFID tag with pre-stored identification data.

In one embodiment, markers are provided to the user by an entity that provides the seed for a crop. For example, a seed supplier can include RFID tags in the bags of seed purchased by growers. The tags can contain data identifying the source of the seed, date information, variety information, genetic information and so forth. Various combinations of such information will be useful in the various applications. The tags can also indicate acceptable, anticipated or required seed treatment information. This information can include, for example, specific or general pesticide, herbicide or fertilizer treatment information as well as specific information regarding scheduling, quantities, strength, etc.

The RFID tags, or other identification markers with communication capabilities, are deposited onto or into the ground at the time of planting. Later, a reader unit, for example a hand-held unit carried by a grower or a unit mounted in a vehicle, tractor or harvesting machine accesses the data. Further, if the markers are writeable, information concerning the treatment applied or other action taken can be recorded on the tag as the reading and writing unit passes nearby. Thus, a record can be developed for a lot of a particular material, for example a field of soybeans.

At various stages, for example at harvest, the data in the markers can be downloaded, for example to a reader unit in a harvesting machine. The data can provide a growing history of the crop. The gathered data can then be rewritten onto one or more of the marker types disclosed throughout this specification, which can then be inserted into the harvested material for further tracking and use. Further, when combined with information identifying the field location, such as a GPS location reading, a yearly historical record of the use of a particular field can be generated. This is useful, for example, in showing that the field has been used only for non-GMO crops for a given number of years.

Although the identification markers 102, 104, 106, 108, 110, 112 of FIG. 1 are depicted as bent strips, such as bendable paper labels, the identification marker chosen for a given application will have a form suited to that application. For example, an RFID tag marker can be a flat, non-bendable object. It will be appreciated that various other marker forms and styles will be appropriate for the various marker types disclosed. The shape of the markers depicted in FIG. 1 is not intended to limiting.

Referring still to FIG. 1, there is depicted a moving stream 114 of bulk flowable, material 116. The material 116 is moving from left to right as one views FIG. 1. Thus, identification marker 112 was dispensed into the stream prior to the other depicted identification markers and it has traveled a distance with its associated bulk flowable material. The stream of material 114 can be on, for example, a conveyor apparatus or it may be propelled through a passage or tube by means of air pressure, gravity or some other movement inducing force. Further, although a linear, stream-like movement is depicted in FIG. 1, the invention is also intended to include other types of material movement as well. For example, identification markers 102, 104, 106, 108, 110, 112 can also be dispensed onto a bulk flowable material 116 that is moving in a curved, arched or circular fashion or onto a material that is being stirred.

The dispenser unit 118 dispenses the identification markers 102, 104, 106, 108, 110, 112 into the bulk flowable material. The main function of the dispenser unit 118 is to store a quantity of marker media and to dispense the identification markers at the proper time via the marker media feeding component 120. When the application uses only pre-prepared identification markers, pre-printed labels for example, the dispenser unit 1 18 need not include a marker preparation component 122. When some information must be added to the identification marker just prior to dispensing, however, the marker preparation component 122 can be included in the dispensing unit 118. In one embodiment, the marker preparation component can be, a printing device such as an ink jet, thermal or other such printer, capable of adding the appropriate information to the marker.

When more sophisticated marking media, for example an RFID marker, is used, the marker preparation component 122 is a device appropriate for communicating with the more sophisticated marker. For an embodiment using an RFID marker, the marker preparation component 122 can be integrated with the dispenser unit 118 or it can be a separate component located elsewhere. In one embodiment, the separately located marker preparation component communicates directly with the identification markers without communicating with the dispensing unit 118.

The signal generation unit 124 can be a separate component, as indicated in FIG. 1, or it can be integrated with the dispensing unit 118. The signal generation unit 124 provides control signals 126, 128 that govern the dispensing of the identification markers by the dispensing unit 118 and, in an embodiment not using pre-prepared markers, the property-related information to be added to the identification marker by the marker preparation component 122. In other embodiments, the signal generation unit 124 provides more than two forms of information to the dispenser unit 118.

The dispensing control signal 126 determines the rate at which the identification markers are dispensed. In one embodiment, the rate is purely a function of time. In this embodiment, the signal generation unit 124 can include a simple timer for generating the signal. At each time interval, one or more identification markers are dispensed into the bulk flowable material. The length of the time interval and the number of markers to be released at each interval can be determined in a variety of ways. An operator can manually enter the values either before or during the dispensing process, the values can be determined automatically based on one or more of a variety of inputs, or the values may be entirely predetermined.

For example, the operator may manually set the values based on one or more observed conditions such as the type of bulk material, the amount of material, the size of the material, the expected land speed of a harvester apparatus, the real-time land speed of a harvester apparatus, the type of marker being dispensed, the requirements of subsequent handlers of the material, or other factors. The same factors can also be used as inputs by a system that automatically determines the values to be communicated. In one embodiment, RFID markers that had been dispensed with seed at the time of planting provide the values. In this type of embodiment, the seed supplier can determine and set the value or values. In another embodiment, the operator can manually direct the release of a marker by manually activating a switch or other such triggering mechanism whenever release of a marker is desired.

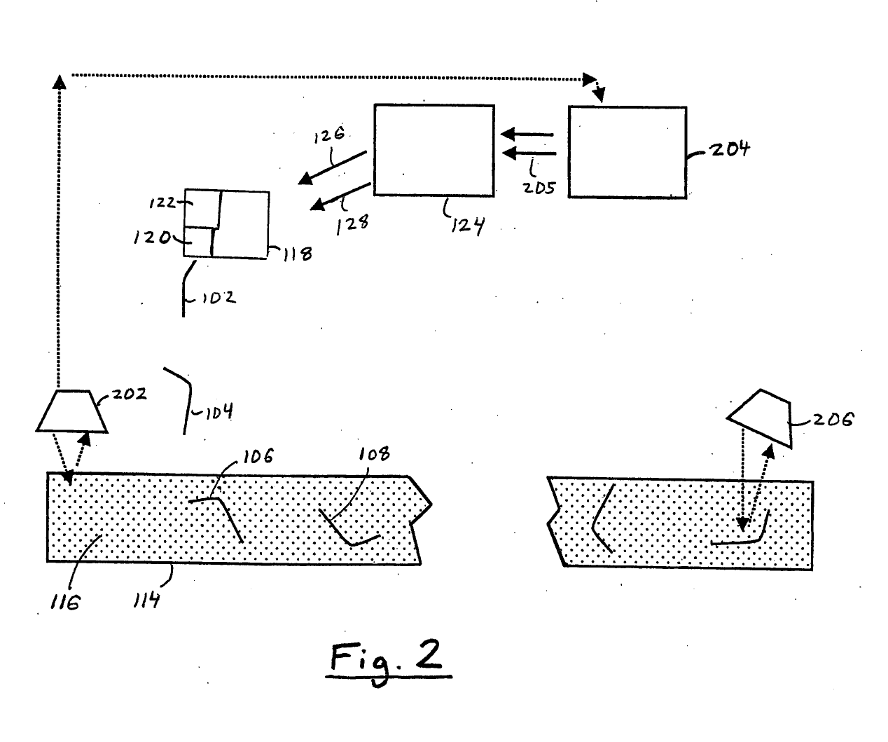

In another embodiment, the rate of dispensing is automatically set not as a function of time but as a function of the volume of bulk flowable material being processed within a given time period. For example, a sensor can determine the volume passing a given point during a given time interval and can communicate this information to the marker media feeding component 120. The dispensing unit 118 will release a given number of markers per unit of volume as desired for the application at hand. In one embodiment, for example, the dispensing unit 118 releases one identification marker for each ten bushels of material processed. In other embodiments, units of weight, mass, length, width or some other measurement is used to determine when a marker or markers should be dispensed. In one embodiment, the volume sensor is located in a harvester apparatus. In other embodiments, the sensor is located near or on some other type of bulk material transporting or conveying apparatus. FIG. 2 depicts a marker dispenser system having a sensor component.

In another, more complex embodiment, the dispensing signal 126 is generated from a combination of manually entered and sensed data. In yet another embodiment, the dispensing signal 126 is generated from a different combination of inputs. For example, the dispensing signal 126 can result from an algorithmic combination of manually input and predetermined data, or of manually input and automatically determined data, or of automatically determined and sensed data or some other useful combination of inputs.

The dispensing signal 126 can also be a function of a later-stage purity requirement. For example, if a later handler needs to guarantee that a given percentage of the bulk flowable material has a given trait, for example that 95% of a grain is non-GMO grain, a determined number of markers can be added per unit of material at a harvesting or other such prior stage to help ensure that the percentage is can be demonstrated. For example, one marker per bushel provides better tracking and routing capabilities than would a concentration of one marker per ten bushels.

The property signal 128 communicates the property information that is to be added to each identification marker. The property information is what identifies the material's trait or traits to other handlers and interested parties. As with the dispensing signal 126, the property signal can be generated from one or more of a variety of inputs. The information may be predetermined, automatically determined or manually input. For example, in various embodiments, a handler can input the information by keyboard, voice command or other input device. A device, for example an RFID marker or a sensor that determines the presence or absence of a property in real time, can automatically determine and communicate the information to the signal generation unit 124. Other embodiments use various different combinations of such inputs to determine the content of the property signal 128.

The control signals 126, 128 themselves can be electrical signals sent by wire or other conductive cable. In other embodiments, the control signals 126, 128 are light energy signals communicated via fiber optic cable. In yet other embodiments, the control signals 126, 128 are radiant energy signals such as infrared or radio frequency signals capable of propagating wirelessly.

The property information communicated by the identification markers can be used in a variety of ways. For example, the bulk flowable material may be transferred or diverted to a specific storage area or processing stream based on the stored property information. In one embodiment, the property information is used to segregate GMO from non-GMO materials. It can also be used to dictate the type of treatment a harvested or unharvested crop is to receive.

The property information on a marker can be read by manually reading or inspecting the markers accompanying the bulk material. Reading may also be accomplished automatically by a reader unit that automatically reads the property information and then signals associated machinery, such as a conveyor, gates, or sprayers to divert, transfer or treat the material as appropriate given the read property or properties. For example, an RFID marker reader reads RFID markers traveling in a stream of harvested crop and sends signals to machinery or human operators that govern the path to be taken by the crop material or the treatment to be applied to that material.

In one application, a reading unit, such as an optical scanner, optical area reader, RFID reader or other such reader as described herein, is located on or next to a grain probe. FIG. 1A depicts a probe system 150, a grain probe system for example, positioned near a quantity of grain or other bulk flowable material 152 containing one or more markers 154. A reader unit 156 is positioned on the probe system 150 on or near the probe arm 157. Alternatively, the reader unit 156 can be directly coupled with the probe arm 157 or it can be an integrated component of the probe arm 157.

The bulk flowable material 152 is depicted as being located in a wagon or cart-type of apparatus 158. The bulk flowable material 152 can alternatively be located on or in any of a variety of other types of transporters or conveyors, such as a conveyer system, a shipping container, a railroad car, a truck or truck trailer, a harvesting or treating apparatus, etc., or one of the other types of transport or storage apparatus described herein.

In operation, when the probe system 150 acts to take a sample of the bulk flowable material 152, the reader unit 156 can attempt to read one or more of the markers 154 located in the vicinity of the sample being taken. This system is advantageous since the reader unit 156 can be included on equipment that may already be in use in conjunction with the handling of the bulk flowable material 152. Further, when the reader unit 156 is located on or sufficiently near the probe arm 157, the reader unit 156 is conveniently transported closer to the bulk flowable material 152, for closer-range marker reading, whenever the probe arm 157 is moved to take a sample. In a related method of operation, the reader unit 156 can be used to read markers even when the accompanying probe arm 157 is not being used to take a sample. In addition, the system can be used to transport the reader unit 156 closer to the bulk flowable material 152 even though a sample will not be taken.

As noted, property information can be used to provide verification or identification of application of a specialized treatment, for example a chemical treatment such as a pesticide, fertilizer or herbicide, to the material. In other embodiments, property information concerning items such as identity or quality is downloaded or transferred from the marker and is stored in a computerized or some other database for future retrieval, tracking and statistical purposes. In some embodiments, the information is used by seed companies or contract seed providers for inventory or production tracking purposes.

In yet another embodiment, the production level of a material lot, a field for example, is quantified by counting and calibrating the markers contained therein. For example, knowledge that the markers were distributed at the rate of one marker per ten bushels can be used to determine the total number of bushels in a given shipment. In this embodiment, the marker reading device need only be capable of counting the markers contained in the lot.

At some point, it may become necessary to remove the identification markers from the bulk flowable material. For example, this may be required for materials destined for use as food by animals or humans. Various methods of removal can be used. The choice of removal method will be dependent on the characteristics of the identification marker being removed. Lighter markers, such as paper labels that are of significantly lighter weight than the accompanying bulk flowable material, can be removed by application of an air stream to the bulk material. Soluble markers can be removed by the application of water or some other suitable solvent. Magnetic forces can be used to remove markers having metallic components. Larger markers can be removed by filters that allow the bulk flowable material to pass but skim off or otherwise remove the marker. Other methods of removal are also available.

In some embodiments, the marker is made of consumable materials. For example, the marker substrate can be made of a consumable paper-like material and the property information can be applied to it via a consumable ink, for example a vegetable or soy-based ink.

In other embodiments, the identification markers are made from biodegradable materials. Biodegradable markers would not have to be removed from the bulk material. They would naturally break down over time.

One system of use involving the present invention is envisioned as described in this and the following two paragraphs. At or prior to the time of planting, coding information is provided by the seed company or the owner of a contract crop production from which the crop variety or seed lot originated. Subsequent operations in the field, such as fertilizer, pesticide or herbicide applications, are recorded electronically by technology presently available, generally referred to as site-specific technology. At harvest or other points of handling, the previously recorded information is transferred to identification markers. This permits the recorded information to physically travel with the crop during subsequent handling and processing.

The site-specific technology can be used as a quality or compliance control tool so that only appropriate operations are allowed. For example, at planting, the crop variety information can be read into the planter monitor. As the crop is planted, information is recorded regarding the specific variety being planted into the field boundaries. At a subsequent step such as pesticide application, a sprayer operator must access the previously recorded crop variety information and coordinate such with the pesticide about to be sprayed. The chosen pesticide application is recorded into a common database relating to the field boundaries. The pesticide application may even be allowed or not allowed based on pre-determined compatibility with the crop variety or on legal compliance issues.

The crop harvester electronic modules can be programmed such that they cannot be overridden, thus ensuring proper marking of crops and treatments. In other words, an operator would be prevented from misidentifying the crop variety, treatment or other information. Eventually, all such information is recorded into a common database relating to the field boundaries, including dates of application, materials used, etc., and can be transferred to identification markers at the time of harvest.

Now referring to FIG. 2, there is shown an identification marker dispensing system 200 similar to that of FIG. 1. The teachings related to FIG. 1 are also applicable to FIG. 2. The system 200 of FIG. 2 depicts an embodiment including sensing and reading systems. The sensing system of this embodiment comprises a sensor unit 202 and a processor unit 204. In a different embodiment, the sensor unit 202 and processor unit 204 are integrated into a single unit. In yet another embodiment, the signal generation unit 124 and the sensor unit 204 are integrated in a single unit.

The sensor unit 202 detects a given property, such as volume, weight, speed, number, or crop variety, etc., of the bulk flowable material 116 and generates a signal related thereto that is sent to the processor unit 204. The processor unit 204 decodes and processes the signal and, if necessary, combines it with other information as described above. Next, the processor unit 204 generates dispensing or property-related information that is passed 205 to the signal generation unit 124.

The processor unit 204 may also be coupled with a global positioning system or other such positioning system to enable the processor unit 204 to relate sensed, input or predetermined information to the location of the bulk flowable material. The location information can be passed to the identification marker via the signal generating unit 124. As noted above, inclusion of location data can permit a historical record of a given field or area to be created.

FIG. 2 also depicts a reader unit 206. As noted above, the reader unit 206 senses the presence of the identification marker, reads the information associated with the marker, or performs both functions. The reader unit 206 can be located with a probe system 150, for example, as described above in relation to FIG. 1A. The reader unit 206, however, can be alternatively or additionally used at a variety of other stages of the bulk flowable material handling and storage process.

The reader unit 206 will generally be in communication with a processing system other than the processor unit 204. Generally, the reading operation will be performed at a time and location significantly removed from the marker dispensing operation. For example, in one embodiment, the marker is dispensed at a growing location at the time of harvest and is not read until after the bulk flowable material is removed from a storage facility location several months later.

FIG. 3 illustrates an agriculture-based use of the identification marker dispensing system. FIG. 3 depicts a harvesting vehicle 302 such as a combine that has harvested a quantity of grain 304. The grain 304 has a plurality of identification markers 306 mixed therewith.

In one embodiment, a dispensing unit and any required associated components, for example the processing, sensing, GPS and other components discussed throughout this specification, are located on the harvesting vehicle 302. The dispensing unit can be located proximate a grain storage compartment 308 of the harvesting vehicle 302. The dispensing unit 118a depicted in FIG. 3 is positioned to deliver an identification marker 306 to a stream of grain as it enters the grain storage compartment 308.

In a related embodiment, the dispensing unit 118b is located proximate a grain conveyance apparatus 310 designed to remove harvested grain from the harvesting vehicle. FIG. 3, for example, depicts a harvesting vehicle 302 in the process of transferring harvested grain 304 to a trailer 312. In this embodiment, identification markers 306 are dispensed into the grain 304 as it is transferred via the conveyance apparatus 310 to the trailer 312.

FIG. 4 depicts a trailer-mounted dispensing unit and system. In FIG. 4, the harvested grain 402 is in the process of being transferred from a trailer unit 404 to a storage bin 406 via a conveyor 408. In this embodiment, the dispensing system 410 is located proximate the grain outflow 412 of the trailer 404. The identification markers are dispensed into the grain 402 as it exits the trailer 404. In a related alternative embodiment, the marker dispensing system is located proximate the conveyor 408 or proximate the end 414 of the conveyor 408 where the grain 402 enters the storage bin 406.

Further in relation to FIG. 4, a marker reading unit can be located on or near the conveyor 408, the trailer unit 404 or the storage bin 406. The dispensing system 410 of FIG. 4 can be omitted or included as needed. The marker reading unit can be used to read the bulk flowable material markers located in its vicinity. The reader can be used to read markers dispensed into the bulk flowable material 402 at an earlier handling or storage stage (for example, at an earlier harvesting, treatment or transport stage, etc.). In applications where the dispensing system 410 is also included, the reader unit can be used to record or to verify the information contained on the recently dispensed markers.

In certain applications it is desirable to update the information contained on the dispensed markers. Information already contained on the markers may need to be changed or deleted, or new information may need to be added to the marker. For example, changes in the content, ownership, treatment history or schedule, location, destination, etc. may have taken place. Further, some information on the marker may have been found to be in error or incomplete in a manner necessitating a change or deletion.

In such situations new markers containing the updated information set can be dispensed. The previously dispensed markers carrying the out-of-date information sets can be removed or their identification codes can be flagged to indicate to other reading systems that their data is not accurate or complete. Alternatively, a date code can be placed on the new markers. Later readers will then only use data read from the markers having the most recent date code.

When changeable identification markers have been employed (RFID markers for example), however, the marker reading unit can be accompanied by an information transmitter component. The information transmitter can be used to send instructions and data to the markers to accomplish an update of the information contained on the markers. This method does not require removal of previously dispensed markers or a dispensing of additional markers.

New or updated marker information can be used to direct the future processing, handling or storage of the bulk flowable material. For example, information specifically identifying such can be placed on the marker. The marker information may designate the performance of a specific treatment or the delivery to a specific destination. The marker is later read and the processing, handling or storage instructions are then automatically or manually carried out.

In a related embodiment, specific information regarding the future handling, processing or storage is not included on the marker. Instructions in the reading system, however, are structured to use the information trait or other information stored on the marker to determine what should be done with the accompanying bulk flowable material. For example, if the marker indicates that the bulk flowable material has a specific property (for example, is a GMO), the reading system will route the material to a destination or storage site designated for such material. Further, the reading system may cause certain handling or treatment steps to be performed based on the origination, historical, destination or other information contained on the marker.

A marker can be read, updated and changed several times during a the complete processing sequence of the bulk flowable material. Several different treatments, processes and transports can thus be directed or governed by the identification markers. Several different reading and/or transmitting units can be used throughout the complete process.

FIG. 5 is a flowchart 500 depicting the general steps and alternatives associated with an embodiment of the present invention. First, the property or properties associated with the bulk flowable material are determined 502. (Note, however, that in an embodiment wherein markers with sensors are dispensed, the step 502 can be performed after the step of dispensing.) Second, the data to be transferred to the identification marker is generated 504. Third, the generated data is applied to the identification marker 506. Fourth, an identification marker is dispensed into the bulk flowable material 508.

After the first marker is dispensed 508, several alternatives are available. If pre-prepared markers are being used, the dispensing step 508 is repeated as necessary 510. As disclosed above, several different types of indicators can be used to trigger a release of a marker. If the identification markers are not pre-prepared, the step of transferring data 506 to the marker is repeated 512 and markers are dispensed 508. This loop 512 is repeated as necessary in accord with the teachings herein.

If the data to be transferred to the marker can change, then control passes 514 to the step of generating the data 504 after each marker is dispensed. This can occur, for example, when a harvesting machine moves to a location where the bulk flowable material is known in advance to have a different or additional property. If the presence of a property can be sensed in real time, then control returns 516 to the step of determining the property 502 after each marker or group of markers is dispensed 508. This can occur, for example, when a harvesting machine contains a real time property sensor component that senses a property as the material is being harvested.

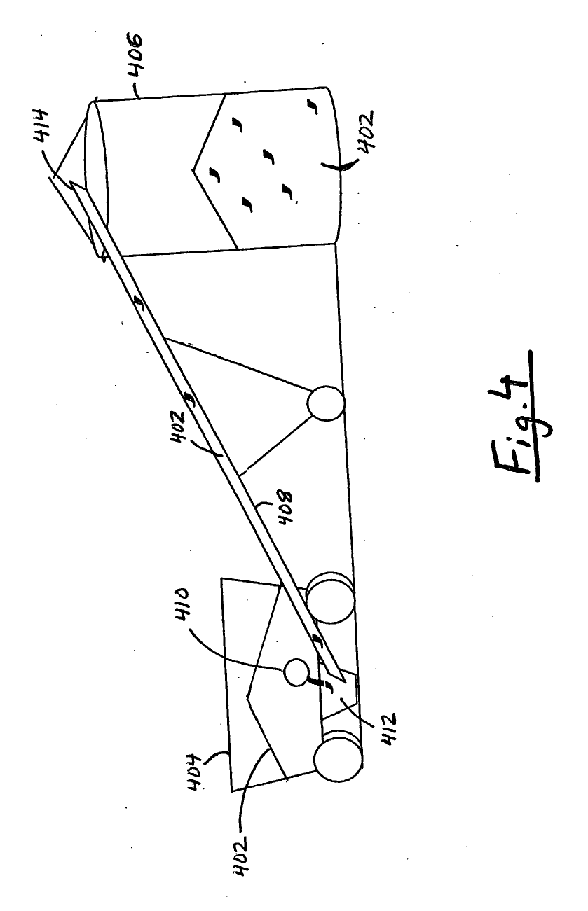

FIG. 6 depicts a roll 600 of a preprinted identification marker appropriate for use with one embodiment of the present invention. The roll 600 contains a single bar code 602. The bar code 602 is chosen to communicate information concerning a property or properties of the bulk material being marked. For instance, the bar code may identify one or more of the properties described herein, such as the variety, the seed source, the location or the owner of the bulk flowable material. The bar code runs for a substantial length of the roll. The orientation of the bar code in this longitudinal manner permits markers to be created and dispensed by slicing or cutting off a portion of the roll 600 at the appropriate time. This orientation also enables the creation of a maximal number of labels from the roll of media.

Pre-prepared markers, such as those of FIG. 6 or any of the other described embodiments, can be supplied by seed companies or other processors for example. Such pre-prepared markers can identify the seed variety, the seed buyer or farmer, and/or other information. The markers can be delivered at the time the seed is delivered or at the time of harvest for example.

In a related embodiment, a roll of blank marker media, similar to the roll of FIG. 6 but without the pre-printed bar code, is used in conjunction with a printer located in the dispensing unit. The printer is designed to print the lines necessary to depict a bar code or other similar optical indicia. The printer receives signals telling it which lines to print. The lines or other similarly continuous code are then printed on the blank roll of media in a longitudinal fashion such as is depicted in FIG. 6. This system has the advantage of added flexibility. A simple system can still be employed, but the property-related information, the bar code or bar code-like structure, can be changed without replacing the roll of marker media.

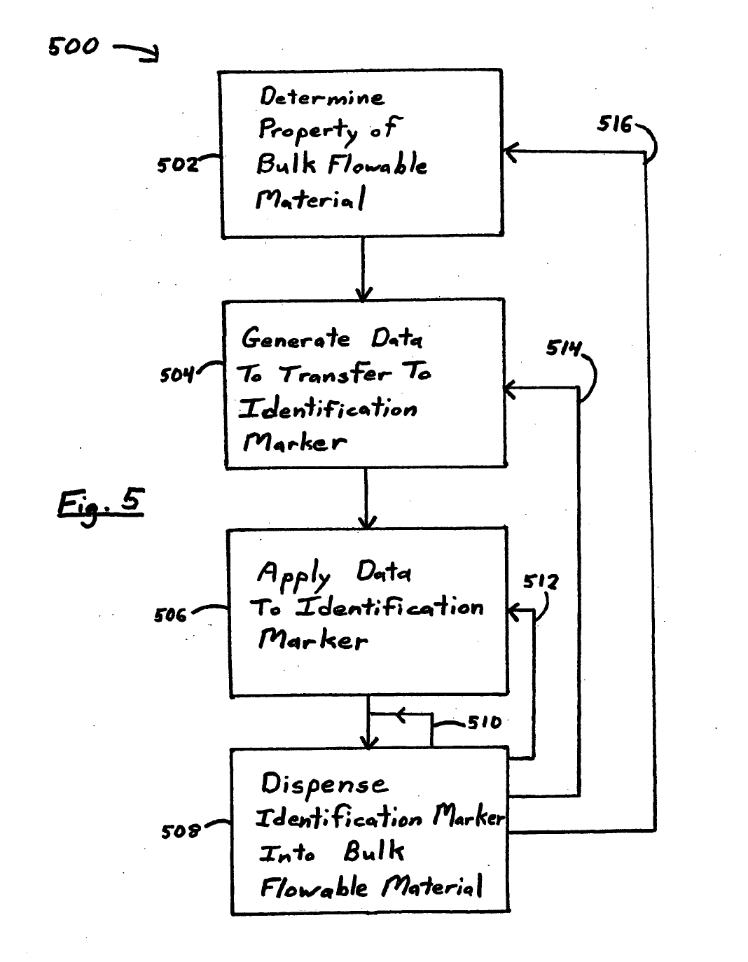

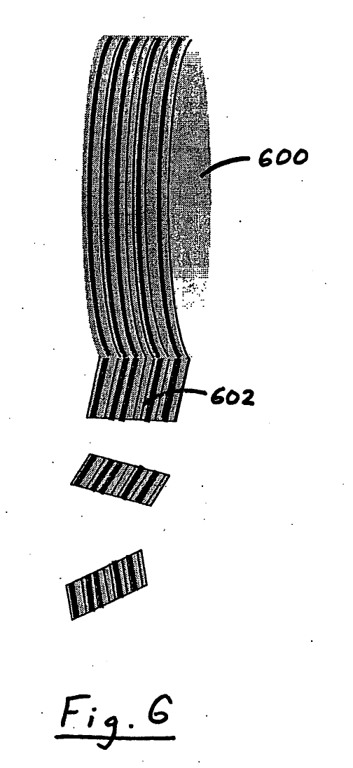

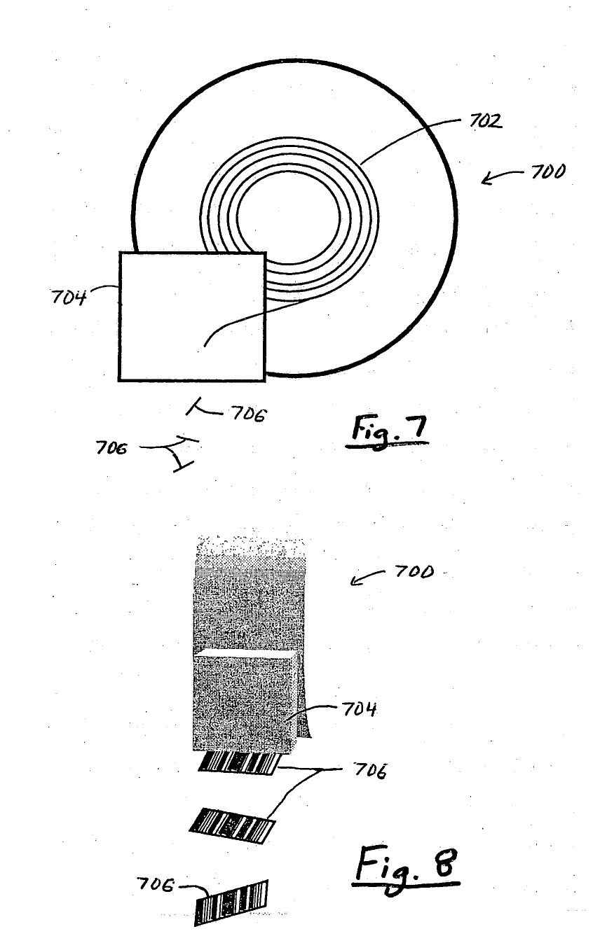

FIG. 7 depicts one embodiment of a dispenser unit 700 appropriate for use with the present invention. This embodiment includes a roll of marker media 702 that can be either pre-printed or at least partially incomplete. A feeding component 704 is depicted proximate the roll 702 and three identification markers 706 are depicted exiting the feeding component 704. In an embodiment using partially incomplete marking media, the dispenser unit 700 includes a printer or other suitable marker preparation component. FIG. 8 provides a frontal view of the dispenser unit 700 of FIG. 7 showing bar code identification markers 706 exiting the feeding component 704.

FIG. 9 depicts an embodiment of a dispensing unit 900 having a cutting apparatus 902 for separating identification markers 904 from a roll of marker media 906. The cutting apparatus 902 contains one or more knife or blade components 908 that rotate with the roll 906. As the blade or blades rotate they separate lengths of media from the roll 906 which are then dispensed.

FIG. 10 depicts a cutaway view of an embodiment of a dispensing unit 1000 containing a marker supply indicator. The dispensing unit 1000 includes an arm or plate 1002, which is biased against a roll of marker media 1004 by a spring 1006. An indicator 1008 is coupled with the interior bar 1002. As the roll 1004 is depleted the interior bar 1002 moves and in turn moves the indicator 1008. A scale 1010 is located proximate the indicator 1008 to indicate the number of markers 1012 that can be dispensed. Alternatively or additionally, the dispenser unit 1000 includes a visual or aural indicator 1014 to signal when the media is depleted or nearly depleted. In a related embodiment, the depletion signal is sent to a remote location such as a harvester cab or other operator station.

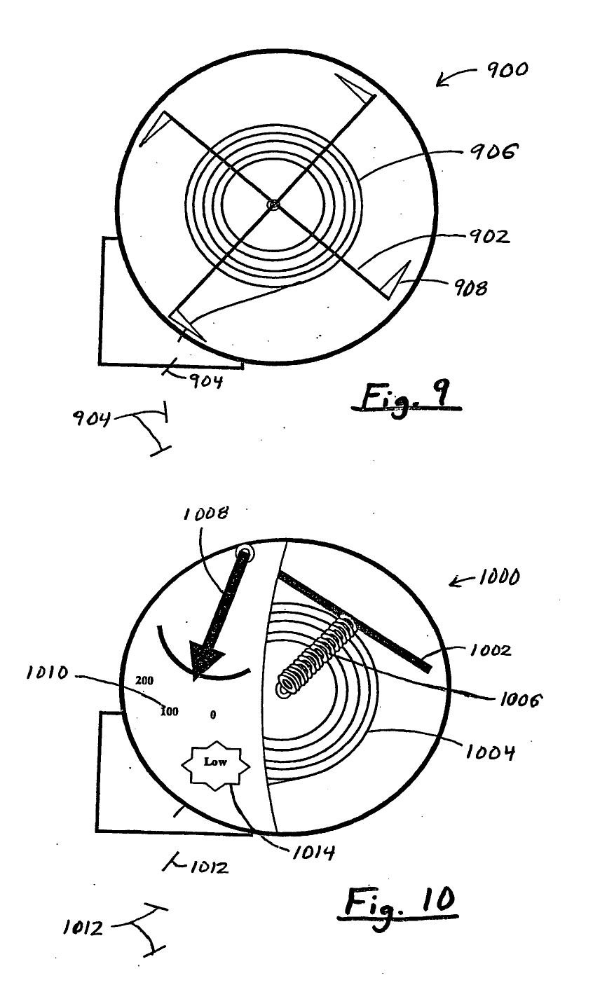

FIG. 11 depicts a label reading apparatus 1100. In an embodiment using deformable or bendable media such as paper labels or the like, there may be a need to flatten the label to improve readability. In particular, long labels or narrow labels may be difficult to image and read. FIG. 11 depicts a label 1102 that has been placed on a receiving surface 1104 of the apparatus. The label reading apparatus 1100 also has a cover 1106 that is lowered against the receiving surface 1104 to flatten the label 1102.

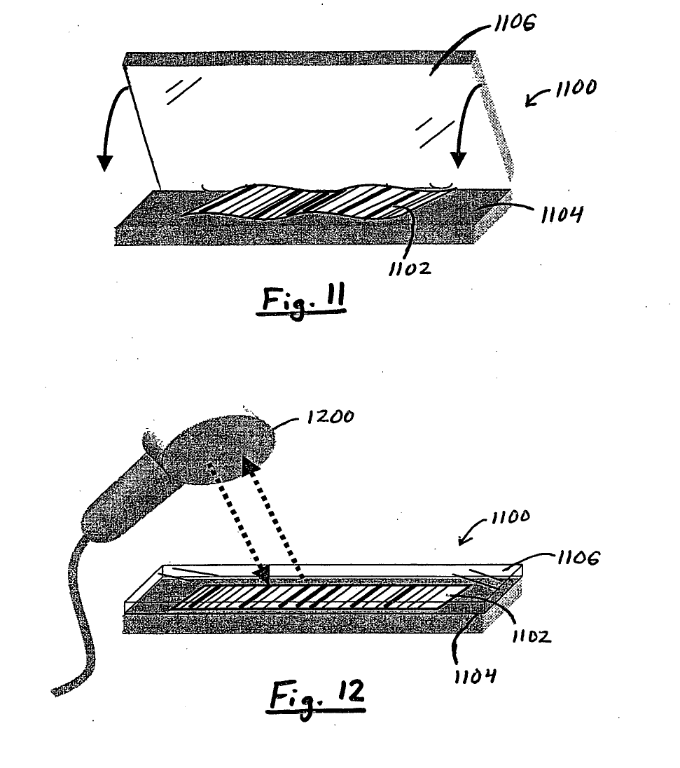

FIG. 12 depicts the label reading apparatus 1100 of FIG. 11 being used by an optical reader 1200 to read the label 1102. By flattening the label, the label reading apparatus 1100 enables a less expensive or less complex reading device to be used. It is not necessary to use a device capable of reading and decoding a curved label. Further, some labels may be curved to such an extent that they are unreadable unless flattened. The apparatus of FIGS. 11 and 12 can be used at any bulk flowable material handling stage requiring optical imaging of curved or bent labels.

When adding a marker to a bulk flowable material to identify some trait or other information associated with that material, it will be, in certain circumstances, advantageous to have a system wherein a dispensed marker will stay with the bulk flowable material granules into which the marker has been deposited. For example, when an indicated trait or information applies only to a portion of the bulk flowable material being collected or handled, it is desirable to insert the marker identifying that trait or information into the portion of the bulk flowable material associated therewith. In other applications, it may be desirable to maintain a uniform distribution of markers throughout a bulk flowable material or throughout a portion thereof. In either case, it is desirable to .dispense a marker that will continue to travel or migrate with its associated bulk flowable material throughout, at least, the portion of the processing or handling sequence wherein the marker and its associated trait or other information may be used or read.

Bulk flowable materials are moved and stored as they are handled or processed. Some handling and storage applications are described herein in relation to FIGS. 1 through 4 for example. One method of moving a bulk flowable material involves causing its individual granules or elements to flow. This can be accomplished in a variety of ways, such as via use of a conveyor, a blower, or some other such apparatus. This type of transport can cause a degree of mixing of the individual granules, thereby changing somewhat their positions relative to each other.

A bulk flowable material can also be moved by moving the container within which it is housed. The container can be moved by truck, ship, aircraft, railroad, etc. The vibration and motion generated by such a moving method can cause the contents, the bulk flowable material, to settle and to jostle about.

The granules of a bulk flowable material can undergo a shifting, relative displacement or migration even when the bulk flowable material is not being transported or moved. For example, materials such as grains, etc., may be subjected to mixing, drying or other procedures while being held in storage. Thus, there are several events that can change the relative positioning of the granules or other elements comprising a bulk flowable material.

Accordingly, in applications wherein it is desired to have a marker travel with a related portion of a bulk flowable material, as well as in applications wherein maintenance of a given distribution of markers throughout a bulk flowable material is desired, consideration should be given to the characteristics of the marker to be employed. A marker system can be chosen that will migrate similarly to the bulk flowable material granules or elements into which it is deposited. In some applications, a marker having the desired migration properties can be developed by giving attention to the size, weight, surface textures and shape of the marker. Thus, when it is known that a bulk flowable material will be processed, handled and stored in a certain fashion, a marker can be developed to have migration properties similar to the migration properties of the bulk flowable material granules into which it is to be deposited.

The factors to be considered in developing a suitable marker include the physical properties of the bulk flowable material granules to be marked; the types of handling, processing, and storage anticipated; and the expected behavior that the bulk flowable material granules will exhibit when subjected to such actions. The relevant properties of the granules or elements include their shape, weight, size and surface textures. In some applications, the desired marker can be developed by mimicking some or all of the physical properties of the granules. Alternatively, a suitable marker can be developed by finding a combination of the shape, weight, size and surface texture properties that will render a marker having the desired migration properties even though one or more of the shape, weight, size, or surface texture properties are somewhat or significantly different from the physical properties of the bulk flowable material granules to be marked.

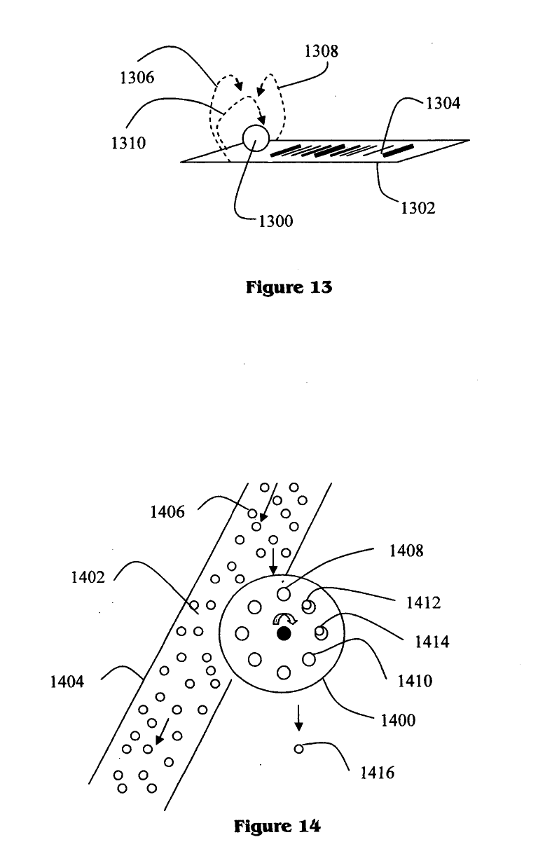

In another embodiment, a marker having suitable migration properties is created by attaching or coupling a marker to a granule or element of the bulk flowable material being marked. FIG. 13 depicts a granule or element 1300 of a bulk flowable material and an identification marker 1302. Although the granule 1300 is depicted as rounded or spherical, it need not be so shaped. The depicted granule shape is only for demonstrative purposes and it is not intended to be limiting. Further, a flat, rectangular marker 1302 bearing a bar code 1304 is depicted in FIG. 13. It should be understood, however, that the identification marker 1302 can be made with any of a wide variety of marker shapes, sizes and materials, as disclosed herein, and it can be associated with any of a wide variety of optical indicia or RFID technology. Further, the element 1300 can be coupled to the marker 1302 at locations other than the end depicted in FIG. 13.

Such a procedure can be used, for example, when the marker 1302 is lightweight compared to the granule 1300 or is of a size or a material suitable for such a use (i.e. a marker having physical properties that will not significantly alter the migration characteristics of the granule or element to which it is attached). In essence, in this embodiment, the marker 1302 “piggy-backs” on a granule 1300 of the bulk flowable material being marked and thereby acquires the migration properties of the attached granule 1300. Testing should be done to determine whether the attachment of the marker 1302 changes the migration properties of the granule 1300. Several marker/granule coupling combinations will adversely affect the migration properties sufficiently to be deemed unsuitable for the uses described above.

In a further embodiment, a lightweight, deformable or non-deformable paper-type marker 1302 is used for attachment to a bulk flowable material granule or element 1300. The marker 1302 can be made from a paper, paper-like, cloth, cloth-like, or other suitable material. The marker 1302 can also be made of a synthetic material. Alternatively, the marker 1302 can be composed of a combination of such materials.

The marker 1302 and the bulk flowable material granule or element 1300 can be coupled via a variety of methods. In one implementation, the marker 1302 is folded or shaped in a manner designed to capture a granule 1300 after it has been deposited into the bulk flowable material. A portion of the marker 1302 can be folded or otherwise formed to create a granule-receiving compartment, cup, box or other such container or receiving chamber.

In a related manner, the marker 1302 can be folded or formed and coupled with a granule 1300 prior to being dispensed into the bulk flowable material. FIG. 14 and its accompanying description discloses an apparatus for isolating or selecting one or more granules or elements from a bulk flowable material for such a purpose. The coupling can be accomplished, for example, by folding or forming the marker 1302 around the granule or element 1300. As depicted in FIG. 13, an end 1306, one of the sides 1308, 1310, both of the sides 1308, 1310, an end 1306 and a side 1308 or 1310, or an end 1306 and both sides 1308, 1310, can be formed or folded around the granule to capture the granule 1300. This can be done with or without the assistance of an adhesive, as needed to meet the demands of the application at hand.

In yet another implementation, an adhesive or gum-like material is applied to the marker 1302. The marker 1302 is then dispensed into the bulk flowable material. Coupling occurs essentially automatically when the adhesive on the marker 1302 happens to come into contact with a granule 1300 as it moves with bulk flowable material into which it has been dispensed.

In another implementation, the identification marker 1302 is coupled with a granule 1300 via application of an adhesive or by applying a combination of an adhesive and a folding or pressure application and the coupled combination is then dispensed into the bulk flowable material. For example, in FIG. 13 an adhesive can be applied to the granule 1300, the marker 1302 or both, without any associated folding or forming, to secure the marker 1302 to the element 1300. Alternatively, a portion of the marker 1302 can be folded or formed, as described above, and an adhesive can be placed within the granule-receiving chamber to form the coupling.

If the marker being used cannot be satisfactorily coupled with a single granule of the bulk flowable material being marked, or if it is not desirable to do so for other reasons, an alternate procedure can be used in some applications. When circumstances permit, two or more granules or elements of the bulk flowable material can be coupled to each other to create a structure with which the marker can be coupled. In context of FIG. 13, the rounded form 1300 would represent the plurality of coupled elements as described in this embodiment. Various means can be used to couple the granules 1300 together. Further, when a marker is coupled with one or more granules or elements, it can serve to keep a lightweight marker from being blown out of the bulk flowable material during processing, handling, transport or storage.

With many bulk flowable materials, granules 1300 can be coupled or clumped together via application of an adhesive-type material. With some bulk flowable materials, water, an appropriate solvent, a non-toxic substance or some other substance can be used to create a paste from an appropriate amount of the bulk flowable material. In yet another implementation, granules 1300 of a bulk flowable material can be compressed by application of pressure or vacuum to couple the granules into a suitable structure. A benefit of the pressure, vacuum, water, and non-toxic implementations (including use of a non-toxic adhesive) is that they can produce a structure that can be safely ingested.

A variety of adhesives can be used to accomplish the couplings disclosed above. The adhesive can be a general or a special purpose glue material. The adhesive can be made of food grade material for example. Such an adhesive is desirable in applications where the adhesive may be consumed by a human or animal at some stage. The adhesive can be made from organic or vegetable-type materials. Further, the choice of adhesive can be based on its compatibility with future processing that it and its accompanying bulk flowable material will receive. The adhesive can also be created from material that can be rendered inert or non-contaminant when subjected to certain chemical or physical applications during processing of the bulk flowable material.

FIG. 14 depicts an apparatus and system that can be used to select one or more granules or elements for coupling with a marker in the manners described above. A granule selection apparatus 1400 is depicted next to a stream of flowing bulk flowable material 1402. The bulk flowable material 1402 is being propelled in any of a variety of methods as described earlier in this specification. For example, it can be blown, dropped, or otherwise conveyed through or on an appropriate conduit 1404. The bulk flowable material 1402 is composed of a plurality of granules or elements (such as 1406 for example).

The granule or element selection apparatus 1400 can be a rotating disk (or other suitable shape) of appropriate thickness that is positioned to extend into the streaming bulk flowable material 1402. The granule selection apparatus 1400 includes a plurality of chambers 1408, 1410, which can be circular (as depicted) or some other appropriate shape. As the disk 1400 rotates (clockwise as depicted or counter-clockwise) through the streaming bulk flowable material 1402, the chambers 1408, 1410 can capture a granule of the bulk flowable material 1402. Two of the chambers 1412, 1414 are depicted in FIG. 14 as having captured a granule or element. As the disk 1400 rotates to a release position for a given chamber 1408, 1410, a granule or element 1416 is ejected. The granule or element 1416 can be ejected by gravity, mechanical, air pressure, or any other suitable means. The selected granule or element 1416 can then be attached to a marker in any of the manners disclosed above.

It will be apparent to one of ordinary skill in the art that the details presented above are beyond what is necessary to practice the present invention. It is thought that the method and apparatus of the present invention will be understood from the preceding description and the appended claims, and that it will be apparent that various changes may be made in the form, construct steps and arrangement of the parts and steps thereof, without departing from the spirit and scope of the invention and without sacrificing the material advantages thereof.

As is evident from the description provided above, the implementation of the present invention varies greatly depending on the circumstances surrounding the implementation. Many variations, implementations and combinations are envisioned and disclosed. The scope of the present invention is intended to cover all variations, omissions, substitutions and combinations which are and which may become apparent from the disclosed embodiments. The scope of the invention should be extended to the claimed invention and all of its equivalents.

1. A marker system for a bulk flowable material, comprising:
a granule of a bulk flowable material; and
a marker containing information related to the bulk flowable material;
wherein said marker is coupled with said granule so that said marker will migrate with said granule and with similar granules of the bulk flowable material located in said granule's surrounding neighborhood.

2. The marker system of claim 1, further comprising an adhesive, wherein said adhesive couples said marker with said granule.

3. The marker system of claim 2, wherein said bulk flowable material is a substance that is intended to be consumed by a living organism and wherein said adhesive is an adhesive that is non-toxic to organisms which may consume said bulk flowable material.

4. The marker system of claim 1, wherein said marker is a deformable marker and wherein said marker is formed into a shape permitting said marker to be coupled with said granule.

5. A method for associating information with a bulk flowable material; comprising the steps of:
selecting a granule from a bulk flowable material to be marked;
creating a marker having information related to the bulk flowable material;
coupling the marker created in said creating step with the granule selected in said selecting step; and
dispensing the marker and granule coupled in said coupling step into the bulk flowable material.

6. The method of claim 5, wherein said coupling step comprises application of an adhesive to couple the marker with the selected granule.

7. The method of claim 5, wherein said coupling step comprises application of a non-toxic adhesive to couple the marker with the selected granule.

8. A marker system for a bulk flowable material, comprising:
a marker carrier structure, comprising;
a first adhesive; and
a plurality of granules of a bulk flowable material, said plurality of granules coupled together with said first adhesive to form said marker carrier structure; and
a marker containing information related to the bulk flowable material;
wherein said marker is coupled with said marker carrier structure so that said marker will migrate with said marker carrier structure and with similar granules of the bulk flowable material located in said marker carrier structure's surrounding neighborhood.

9. The marker system of claim 8, further comprising a second adhesive, wherein said second adhesive couples said marker with said marker carrier structure.

10. The marker system of claim 8, wherein said bulk flowable material is a substance that is intended to be consumed by a living organism and wherein said first adhesive is an adhesive that is non-toxic to organisms which may consume said bulk flowable material.

11. A method for associating information with a bulk flowable material; comprising the steps of:
selecting a plurality of granules from a bulk flowable material to be marked;
forming the plurality of granules selected in said selecting step into a marker carrier structure;
creating a marker having information related to the bulk flowable material;
coupling the marker created in said creating step with the marker carrier structure formed in said forming step; and
dispensing the marker and marker carrier structure coupled in said coupling step into the bulk flowable material.

12. The method of claim 11, wherein said coupling step comprises application of an adhesive to couple the marker with the marker carrier structure.

13. The method of claim 11, wherein said coupling step comprises application of a non-toxic adhesive to couple the marker with the marker carrier structure.

14. The method of claim 11, wherein said forming step comprises application of an adhesive to form the marker carrier structure from the selected granules.

15. The method of claim 11, wherein said forming step comprises application of a non-toxic adhesive to form the marker carrier structure from the selected granules.
